(19) United States
(12) Patent Application Publication
(10) Pub. No.: US 2008/0054677 A1
(43) Pub. Date: Mar. 6, 2008

(54) Drag reducing vehicle attachment

(76) Inventor: Travis J. McGee, Danvers, MA (US)

Correspondence Address: S. Scott Gordon;Advantage Patent Services, Inc., 1748 E. Pony Ln., Gilbert, AZ, 85296, US

(21) Appl. No.: 11/517,137

(22) Filed: Sep. 6, 2006

(51) Int. Cl. B62D 35/00

(52) U.S. Cl. 296/180.1

(57) ABSTRACT

An apparatus and system for reducing drag on a vehicle are described. In one embodiment, the apparatus includes a deflector configured to divert air-flow around a vehicle body. The apparatus may further include an attachment member removably coupled to the deflector, the attachment member configured to attach the deflector to the vehicle body.

### BACKGROUND OF THE INVENTION

1. Field of the Invention

This invention relates to automotive aerodynamics and more particularly relates to a vehicle attachment for reducing drag.

2. Description of the Related Art

Fossil fuel consumption is one of the primary ecological problems facing today's society. As the rate of fuel consumption increases, the volume of pollution emitted into the atmosphere also increases. Moreover, the supply of fossil fuel is diminishing. Vehicles are expensive to operate and products requiring fossil fuel for manufacturing are expensive to produce because of a consistent upward trend in fuel prices. While there is currently no comprehensive solution to global economic and ecological issues associated with fossil fuel over-consumption, it is well settled that minimizing consumption is a step in the direction of a workable solution.

Each year, vehicle use accounts for a large portion of fuel consumption. FIG. 1 illustrates a typical gasoline burning vehicle common in the United States. In a typical vehicle, gasoline is consumed at varying rates depending on whether the vehicle is idling, accelerating, or maintaining a constant velocity. Gasoline is typically burned at the fastest rates while the vehicle is accelerating and the slowest rates while the vehicle is idling. A vehicle will generally burn more gasoline while maintaining a constant velocity then it will burn while idling. Fuel consumption of the increases logarithmically as the speed of a vehicle goes over approximately 45 mph, which is usually known as the sweet spot.

The rate of consumption while maintaining a constant velocity is effected by friction forces from contact between the vehicles tires and the road, friction between the working components of the vehicle, and friction caused by wind drag on various portions of the vehicle body. Generally, the drag force is highest at the vehicles bumper, and particularly on the vehicles license plate. For example, the front bumper of the vehicle illustrated in FIG. 1 creates a higher drag on the vehicle, per unit of frontal area, than any of the other portion of the vehicle, because the bumper is the surface that is most perpendicular to the direction of air flow.

Although various license plate covers are available, none of them significantly improve the coefficient of drag of the license plate or of the front bumper of the vehicle. Large diesel tractors often include air foils positioned on the top of the cab for improving aerodynamics of the trailer, but none of those air foils divert airflow around the frontal body of the tractor itself. Furthermore, those air foils are typically permanently mounted on the vehicle, and are too large to be practical for common commuter vehicles.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view diagram illustrating a conventional automobile.

FIG. 2A is a side view diagram illustrating a vehicle with one embodiment of an attachment for reducing drag.

FIG. 2B is a front view diagram illustrating a vehicle with one embodiment of an attachment for reducing drag.

FIG. 3 is a front view diagram illustrating one embodiment of an apparatus for reducing drag on a vehicle.

FIG. 4 is a perspective view diagram illustrating one embodiment of an apparatus for reducing drag on a vehicle.

FIG. 5A is a front view diagram illustrating one embodiment of an attachment member.

FIG. 5B is a cross-section view diagram illustrating one embodiment of an attachment member.

FIG. 6 is a cross-section view diagram illustrating one embodiment of a system for reducing drag on a vehicle.

FIG. 7 is an exploded view diagram illustrating one detailed embodiment of a system for reducing drag on a vehicle.

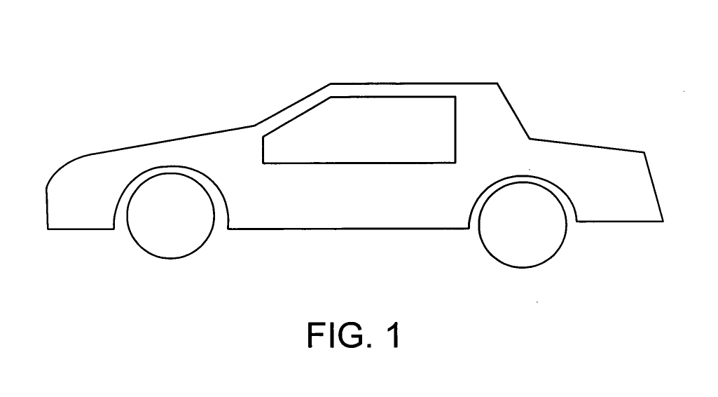

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

An apparatus and system for reducing drag on a vehicle are described. In one embodiment, the apparatus includes a deflector configured to divert air-flow around a vehicle body. The apparatus may further include an attachment member removably coupled to the deflector, the attachment member configured to attach the deflector to the vehicle body. In one embodiment, the system includes a drag reducing vehicle attachment and a fastener configured to fasten the attachment member to a body member of a vehicle. The drag reducing vehicle attachment may further comprise a deflector configured to couple to the body member of the vehicle, the deflector comprising at least one surface configured to divert air-flow away from the body member of the vehicle, and an attachment member removably coupled to the deflector, the attachment member configured to attach the deflector to the body of the vehicle.

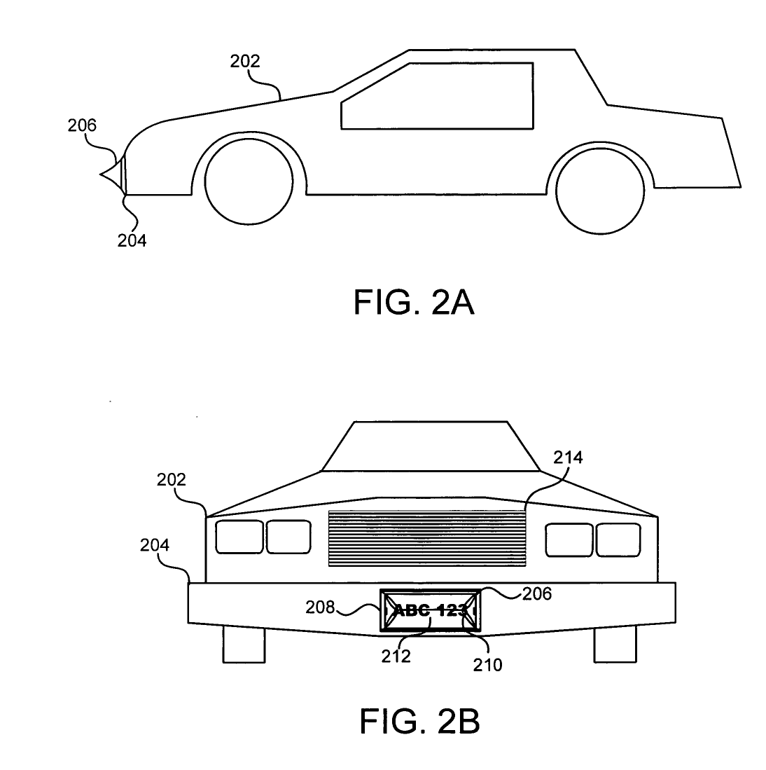

FIG. 2A is a side view diagram illustrating a vehicle 202 with one embodiment of an attachment for reducing drag. Although FIG. 2A depicts the apparatus 206 coupled to the front bumper 204 of the vehicle 202, one of skill in the art may envisage other embodiments in which the apparatus 206 is coupled to other body members of the vehicle 202.

In certain embodiments, the license plate may create a high level of drag on the vehicle with respect to other surfaces of the vehicle. The drag of a particular body member of a vehicle can be calculated from the coefficient of drag corresponding to that body member. For example, the overall coefficient of drag of a Honda Insight™ is approximately 0.27. However, the coefficient of drag of a license plate is approximately 1.0. When the apparatus 206 is coupled to the front bumper 204 of the Honda Insight™, the coefficient of drag of the license plate portion may be reduced from approximately 1.0 to approximately 0.3, because the coefficient of drag of the apparatus 206 may be approximately 0.3.

FIG. 2B is a front view diagram illustrating a vehicle 202 with one embodiment of an attachment for reducing drag. In one embodiment, the apparatus 206 for reducing drag includes an attachment member 208 and a deflector 210. In one embodiment, the apparatus 206 may be attached to a body member of the vehicle 202. For example, the apparatus 206 may be attached to the front bumper 204 of the vehicle 202.

In such an embodiment, the deflector 208 may be configured to divert air-flow around a body member of the vehicle 202. For example, the deflector 208 may divert air-flow around the license plate 212, the front bumper 204, the front grill 214, and the like. In such an embodiment, the apparatus 206 reduces the coefficient of drag of covered and adjacent body members. Consequently, the coefficient of drag of the entire vehicle 202 is reduced and the vehicle 202 may operate with improved efficiency.

For example, as described in relation to FIG. 2A, the apparatus 206 may reduce the drag coefficient of a license plate 212 from approximately 1.0 to approximately 0.3. In the case of the Honda Insight™ this reduction in coefficient of drag of the license plate 212 may result in an overall fuel efficiency improvement of between approximately 1% and 4%. Therefore, the apparatus 206 may save one to four gallons of fuel for every one hundred gallons consumed, when used with the Honda Insight™. The following formula describes the drag force on a vehicle.

Drag Force (N)=C_{D}*½ρv²*A

Here, the Drag Force is calculated in Newtons. The coefficient of drag of the body member (C_{D}) is a unitless constant. The drag force calculation also takes into account the kinetic energy of the air flowing over the body member. The kinetic energy is the value (½ρv²), which includes the density of the air (ρ) and the velocity (v) of the air flow with respect to the body member. These values are multiplied by the frontal area (A) of the vehicle or body member incident to the air flow. The power, which is proportional to the volume of fuel, consumed by the vehicle 202 is given by the following equation.

Power (Watts (J/s))=Drag Force (N)*v(m/s)

In the case of a vehicle, there may be several sources of drag such as friction between engine components, rolling friction between the tires and the pavement, and aerodynamic drag. The following equation is an expanded version of the power equation above which shows the contributions of these various sources of drag to the required drive power.

Power=av+bv²+cv³

Therefore, the fuel consumption of a vehicle 202 is proportional to the drag force on the vehicle 202. A reduction in drag force may result in an exponential reduction in fuel consumption. Here the overall coefficient of drag C_{D} is broken down into its components. The rolling resistance component (a) characterizes the rolling resistance of the tires to pavement, wheels, axels, and the like. The engine resistance (b) characterizes the friction from driving pumps and motors within the engine such as air-conditioning pumps, alternator motors, and the like. This value is multiplied by the square of the velocity. The aerodynamic drag component (c) characterizes the contribution of wind resistance to the vehicle 202. This value is multiplied by the cube of the velocity, illustrating that the power required to counteract wind resistance on the vehicle 202 goes up by a power of three as the velocity increases.

In the exemplary embodiment described above, the Honda Insight™ may have an approximate surface area of twenty three square feet that is incident to the air flow. The license plate 212 may account for approximately one square foot of the twenty three square feet of incident surface area. In such an embodiment, reducing the coefficient of drag C_{D} of the license plate 212 from approximately 1.0 to approximately 0.3 may reduce the total coefficient of drag of the vehicle 202 by approximately four to six percent. In order to get a one percent improvement in fuel efficiency, the overall coefficient of drag C_{D} of the vehicle 202 may require an improvement of about 6% at 20 mph; by 4% at 40 mph; by 2% at 60 mph; and by 1.5% at 70 mph. Therefore, the apparatus 206 may improve the fuel efficiency of the Honda Insight™ by about 2.5% for average highway driving.

Furthermore, the deflector 210 may divert the direction of air-flow incident to other body members, thereby reducing the drag on adjacent body members as well, especially at higher highway speeds. Although the apparatus 206 may be coupled to the license plate 212 area in the exemplary embodiment described above, one of ordinary skill in the art will recognize other configurations in which the apparatus 206 may be coupled to various other body members of a vehicle 202. In an alternative embodiment, the apparatus 206 may be coupled to a license plate holder or frame.

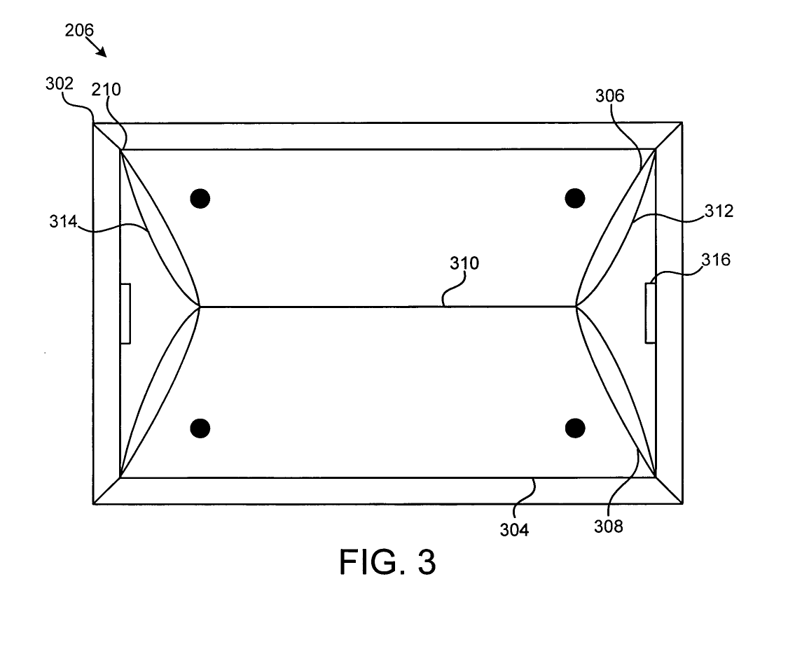

FIG. 3 is a front view diagram illustrating one embodiment of the apparatus 206 for reducing drag on a vehicle 202. In one embodiment, the apparatus 206 may include a deflector 210 for diverting air-flow around a body member (e.g., a front bumper 204) of a vehicle 202. The apparatus 206 may further include an attachment member 208. The attachment member 208 may be removably coupled to the deflector 210. Additionally, the attachment member 208 may attach the deflector 210 to the body member of the vehicle 202.

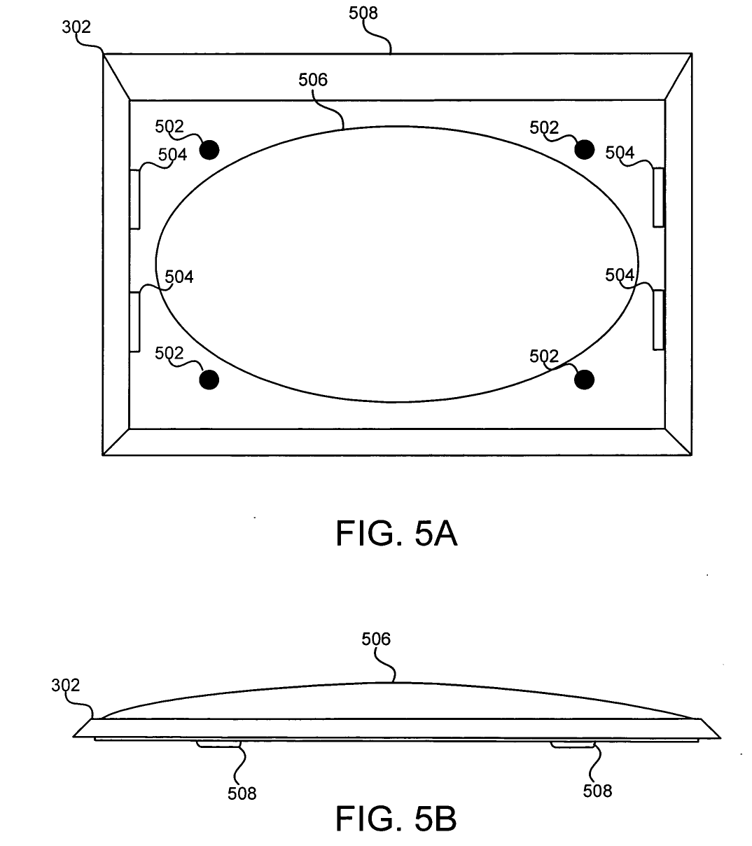

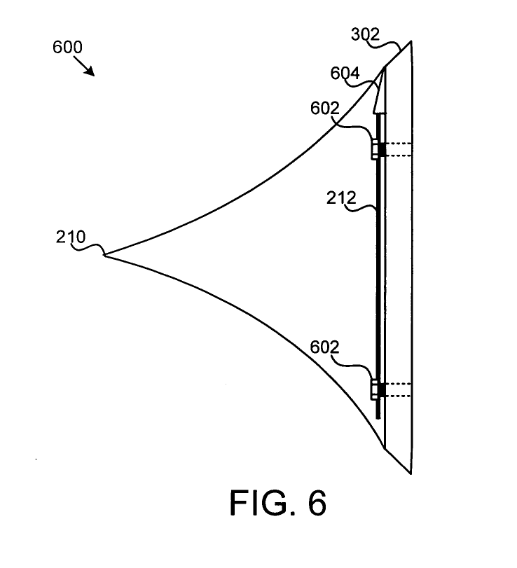

In one embodiment, the attachment member 208 may include a mounting plate 302. The mounting plate 302 may receive the deflector 210. Further embodiments of the mounting plate 302 are discussed below in relation to FIGS. 5A, 5B, and 6. One of ordinary skill in the art will recognize that a mounting plate 302 is not the only attachment member 208 configurable to attach the deflector 210 to a body member of a vehicle 202. For example, an attachment member 208 may include a strap, hook, bolt, pin, clamp, adhesive layer, or other device for attaching the deflector 210 to the body member.

In one embodiment, the deflector 210 may be formed of a polymer based material such as plastic. In a further embodiment, the deflector 210 may be formed of a transparent material such as clear plastic and the like. For example, the deflector 210 may be formed of transparent plastic using an injection molding process. In such an embodiment, the deflector 210 may keep the license plate 212 or other body member clear of dirt or debris, while allowing other vehicle operators to view the license plate 212. One of ordinary skill in the art may recognize other material and manufacturing methods suitable for forming the deflector 210.

In a further embodiment, the deflector 210 may include a base 304 that may couple to the attachment member 208. The deflector 210 may additionally include one or more curved surfaces for diverting air-flow. Alternatively, the deflector 210 may include one or more planar surfaces positioned at an angle with respect to the body member suitable for diverting air-flow around the body member. The deflector 210 may also include a first longitudinal surface 312 extending outwardly from the base 304, and a second longitudinal surface 314 extending outwardly from the base 304. The deflector 210 may additionally include a first lateral surface 306 and a second lateral surface 308. The lateral surfaces 306, 308 may also extend outwardly from the base 304.

In one embodiment, the first lateral surface 306 and the second lateral surface 308 may be joined along a lateral axis 310. The junction may be formed of a crease, a fold, a bend or a curve in a continuous body of material. Alternatively, the junction may be formed of a joining of two discrete surfaces using an adhesive, ultrasonic plastic weld, or the like. Additionally, the first longitudinal surface 312 and the second longitudinal surface 314 may be joined with the first lateral surface 306 and the second lateral surface 308 at opposing ends of the lateral axis 310.

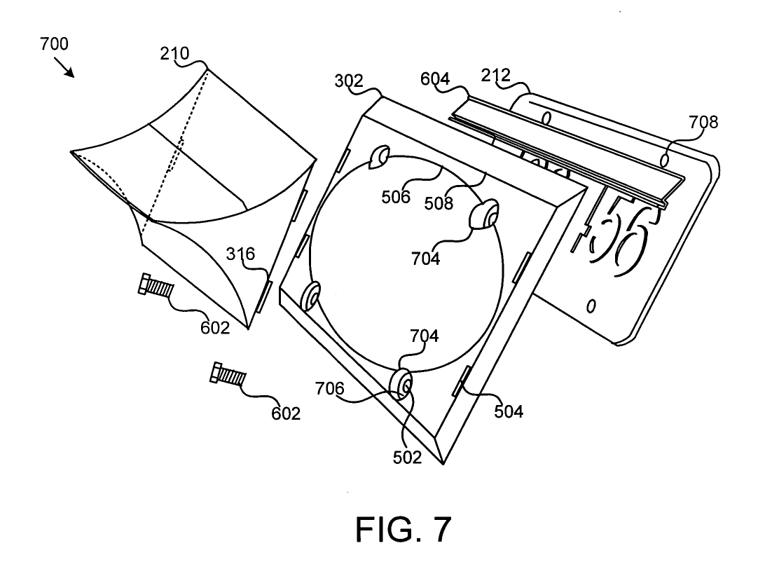

In a further embodiment, the deflector 210 may include a protrusion, hole, or like coupling member 316 for coupling the deflector to the attachment member 208. The details of various embodiments for coupling the deflector 210 to the attachment member 208 are discussed in greater detail with reference to FIGS. 5A, 5B, and 7 below.

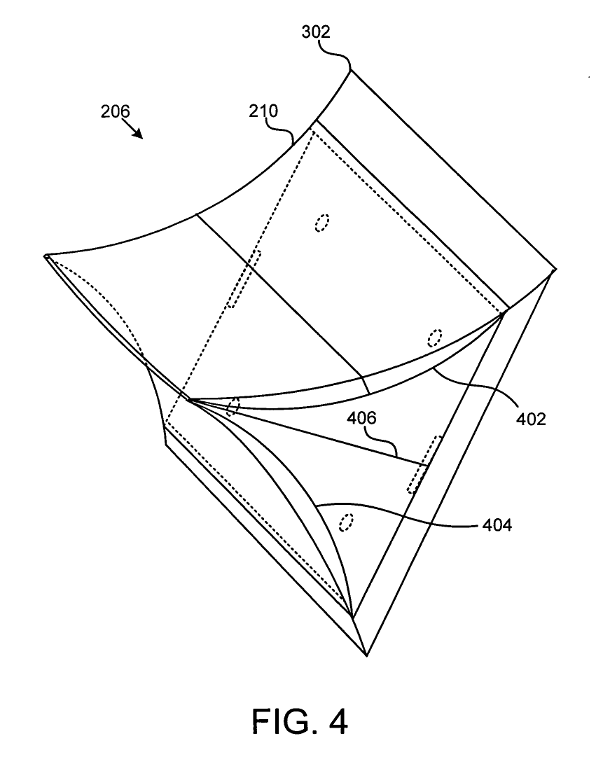

FIG. 4 is a perspective view diagram illustrating one embodiment of an apparatus 206 for reducing drag on a vehicle 202. As discussed above with relation to FIG. 3, the deflector 210 may include one or more curved surfaces. In various embodiments, a substantial portion of the surfaces may be curved to enhance the aerodynamic characteristics of the deflector 210. For example, the junction along the lateral axis 310 may substantially form a curve or arch. Additionally, one or more of the lateral surfaces 306, 308 and one or more of the longitudinal surfaces 312, 314 may be curved.

In a further embodiment, the longitudinal surfaces 312, 314 may include multiple sub-surfaces. The sub-surfaces may be curved, or may be planar surfaces arranged to form a substantially curved longitudinal surface 312, 314. For example, FIG. 4 illustrates an exemplary embodiment, where the first longitudinal surface 312 includes a first sub-surface 402 and a second sub-surface 404. The sub-surfaces 404, 406 may be joined along a junction 406. In such an embodiment, the sub-surfaces 404, 406 may be arranged in substantially the same, longitudinal, direction. However, the sub-surfaces 404, 406 may be arranged at different angles and with different curves. In a further embodiment, the lateral surfaces 306, 308 may also include multiple sub-surfaces.

FIG. 5A is a front view diagram illustrating one embodiment of an attachment member 208. In one embodiment, the attachment member 208 may include a mounting plate 302. In various embodiments, the attachment member 208 may be formed of a polymer, metal, or the like. In a certain embodiment, the attachment member 208 may be formed of a transparent material.

In one embodiment, the mounting plate 302 includes one or more holes 502 for attaching or fastening the mounting plate 302 to the body member using a fastener. For example, the mounting plate 302 may be attached to the front bumper 204 of a vehicle 202 with up to four bolts or screws inserted through the holes 502 in the mounting plate 302 and into holes in the front bumper 204 for receiving a license plate 212. Indeed, the mounting plate 302 may additionally couple to the license plate 212.

Additionally, the mounting plate 302 may include one or more slots 504 for receiving the deflector 210. For example, as discussed above with relation to FIG. 3, the deflector 210 may include one or more protrusions 316. The protrusions 316 may be configured to engage the slot 504 and attach therein, thereby securing the deflector 210 to the mounting plate 302. For example, the protrusion 316 may include a spur or edge and a flexible flange portion. The flange portion may flex allowing the spur or edge to engage the slot 504. The spur or edge may then interlock with the interior of the slot 504, securing the deflector 210. Alternatively, the mounting plate 302 may include grooves, holes, protrusions, or other coupling member for coupling the deflector 210 to the mounting plate 302.

In a further embodiment, the mounting plate may include a sub-deflector 506. The sub-deflector 506 may include one or more curved surfaces. In a particular embodiment, the sub-deflector 506 may be formed of a bubble portion of the mounting plate 302. The bubble may be substantially oval or elliptical. The sub-deflector 506 may divert air-flow around the body member of the vehicle 202 when the main deflector 210 is removed from the mounting plate 302 or broken. For example, since the deflector 210 may extend several inches from the front of the vehicle 202, it may be easily damaged in city driving conditions. Since city driving conditions often require tight parking and close following, the potential for damage to the deflector 210 is high. However, the deflector 210 may provide some protection to the body member in the event of a head-on collision, because the deflector may crush and absorb a portion of the collision impact. Indeed, the apparatus 206 may provide substantial protection to the body member as a result of the multilayered structure and hard, durable, impact resistant plastic included in various embodiments of the apparatus 206. Since the deflector 210 is removably coupled to the attachment member 208, it may be removed and stored for city driving, and replaced for highway driving. The sub-deflector 506 may still provide some air-flow diversion when the deflector 210 is removed.

FIG. 5B is a cross-section view diagram illustrating the mounting plate 302. In such an embodiment, the mounting plate 302 may include angled or curved edges for enhanced aerodynamics. Additionally, the mounting plate 302 may include one or more structural supports 508 for protecting against breakage or damage at the structurally vulnerable interface between the mounting plate 302 and the body member of the vehicle 202. Additionally, the mounting plate 302 may include a sub-deflector 506 for diverting air-flow around the body member in the absence of the deflector 210.

FIG. 6 is a cross-section view diagram illustrating one embodiment of a system 600 for reducing drag on a vehicle 202. In one embodiment, the system 600 includes a deflector 210 and an attachment member 208. The attachment member 208 may be a mounting plate 302.

In a further embodiment, the system may include one or more fasteners 602 for fastening the attachment member to the body member of the vehicle 202. For example, the fastener 602 may include a screw or a bolt. In the depicted embodiment, the fastener 602 is a threaded bolt coupled through the hole 502 to the body member. In an alternative example, the fastener 602 may include a hook, an adhesive strip, a strap, a clamp, or the like.

In a further embodiment, either the mounting plate 302 or the deflector 210 may connect to, or cover a license plate 212. In such an embodiment, the fastener 602 may include the bolt or screw for fastening the license plate 212 to the front bumper 204 of a vehicle 202. The fastener 602 may pass through holes in the license plate 212 and the holes 502 in the mounting plate 302, and secure to threaded holes in the bumper 204. In various embodiments, the license plate 212 may be coupled to either the front side or the back side of the mounting plate 302.

In one embodiment, a display member 604 may be coupled to either the deflector 210 or the mounting plate 302. The display member 604 may display a message. For example, a company logo or advertisement may be displayed by the display member 604. The display member may include a support backing or slide with a flange for securing the message. Alternatively, the display member may include an electronic display, a message secured with adhesive to a display portion of the mounting plate or the deflector, or the like.

FIG. 7 is an exploded view diagram illustrating one detailed embodiment of a system 700 for reducing drag on a vehicle 202. In the depicted embodiment, the deflector 210 and the mounting plate 302 may be formed of a transparent material, so that the license plate 212 coupled to the back side of the mounting plate 302 is visible. The display member 604 may be coupled to the mounting plate 302. In such an embodiment, a the top flange 508 of the mounting plate 302 may be formed to receive the display member 604 and prominently display the message.

The mounting plate 302 may include a sub-deflector 506 and one or more holes 502. The holes may be formed in a recessed portion or countersink 704. The countersink 704 may additionally include a structurally supported flange 706 for interfacing the head of the fastener 602. In such an embodiment, the display member 604 may be coupled to the mounting plate 302. The fastener 602 may then be inserted through the hole 502 in the mounting plate 302 and the hole in the license plate 708 and attached to the body member of the vehicle. The protrusion 316 of the deflector 210 may then engage 504 the slot 504 securing the deflector 210 to the mounting plate 302.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a deflector configured to divert air-flow around a front bumper of a vehicle;
an attachment member removably coupled to the deflector, the attachment member configured to attach the deflector to the front bumper of the vehicle;
wherein the attachment member further comprises a mounting plate configured to attach to the front bumper of the vehicle, the mounting plate further configured to receive the deflector;
wherein the mounting plate further comprises a portion forming a slot, the slot configured to receive a mated portion of the deflector and to secure the deflector to the mounting plate;
wherein the mated portion of the deflector further comprises a portion forming a protrusion, the protrusion configured to engage the slot and to secure the deflector to the mounting plate; and
wherein the mounting plate further comprises a sub-deflector formed thereon, the sub-deflector configured to divert air-flow around substantially the same area as the deflector.

2. (canceled)

3. (canceled)

4. The apparatus of claim 1, wherein the mounting plate further comprises a portion defining a hole, the hole configured to receive a fastener, wherein the fastener is configured to attach the mounting plate to the front bumper of the vehicle.

5. The apparatus of claim 1, wherein the mounting plate is further configured to couple to a vehicle license plate.

6. The apparatus of claim 5, wherein at least one of the deflector and the mounting plate comprises a transparent material.

7. (canceled)

8. The apparatus of claim 1, wherein the deflector further comprises a curved surface.

9. The apparatus of claim 1, wherein the deflector further comprises:
a base configured to couple to the attachment member;
a first longitudinal surface extending outwardly from the base;
a second longitudinal surface extending outwardly from the base;
a first lateral surface extending outwardly from the base;
a second lateral surface extending outwardly from the base;
wherein the first lateral surface and the second lateral surface are joined along a lateral axis; and
wherein the first longitudinal surface and the second longitudinal surface are joined with the first lateral surface and the second lateral surface at opposing ends of the lateral axis.

10. The apparatus of claim 9, wherein at least one of the first longitudinal surface, the second longitudinal surface, the first lateral surface, and the second lateral surface further comprises a plurality of sub-surfaces, the sub-surfaces arranged in a substantially similar direction.

11. A system, comprising:
a drag reducing vehicle attachment comprising:
a deflector configured to divert air-flow around a front bumper of a vehicle;
an attachment member removably coupled to the deflector, the attachment member configured to attach the deflector to the front bumper of the vehicle;
wherein the attachment member further comprises a mounting plate configured to attach to the front bumper of the vehicle, the mounting plate further configured to receive the deflector;
wherein the mounting plate further comprises a portion forming a slot, the slot configured to receive a mated portion of the deflector and to secure the deflector to the mounting plate;
wherein the mated portion of the deflector further comprises a portion forming a protrusion, the protrusion configured to engage the slot and to secure the deflector to the mounting plate; and
wherein the mounting plate further comprises a sub-deflector formed thereon, the sub-deflector configured to divert air-flow around substantially the same area as the deflector; and
a fastener configured to fasten the attachment member to the front bumper of the vehicle.

12. (canceled)

13. (canceled)

14. The system of claim 11, wherein the mounting plate further comprises a portion defining a hole, the hole configured to receive the fastener, wherein the fastener is configured to attach the mounting plate to the front bumper of the vehicle.

15. The system of claim 11, wherein the sub-deflector is configured to divert air-flow around the front bumper of the vehicle in response the deflector being uncoupled from the attachment member.

16. (canceled)

17. The system of claim 11, wherein the deflector further comprises:
a base configured to couple to the attachment member;
a first longitudinal surface extending outwardly from the base;
a second longitudinal surface extending outwardly from the base;
a first lateral surface extending outwardly from the base;
a second lateral surface extending outwardly from the base;
wherein the first lateral surface and the second lateral surface are joined along a lateral axis; and
wherein the first longitudinal surface and the second longitudinal surface are joined with the first lateral surface and the second lateral surface at opposing ends of the lateral axis.

18. The system of claim 11, wherein at least one of the deflector and the attachment member further comprise a transparent material, wherein a vehicle license plate coupled to the at least one of the deflector and the attachment member is visible through the material.

19. The system of claim 11, further comprising a display member coupled to at least one of the deflector and the attachment member, the display member configured to display a message.

20. (canceled)
